(19) United States
(12) Patent Application Publication
(10) Pub. No.: US 2013/0334328 A1
(43) Pub. Date: Dec. 19, 2013

(54) DUAL-VALVE THERMOSTAT

(71) Applicants: Marty Iwamuro, Columbus, IN (US); Curtis Hicks, Columbus, IN (US); Randy Cvelbar, Columbus, IN (US); Jeremiah Hendren, Butlerville, IN (US); John Rohde, Columbus, IN (US); Bruce Abel, Waterford, MI (US)

(72) Inventors: Marty Iwamuro, Columbus, IN (US); Curtis Hicks, Columbus, IN (US); Randy Cvelbar, Columbus, IN (US); Jeremiah Hendren, Butlerville, IN (US); John Rohde, Columbus, IN (US); Bruce Abel, Waterford, MI (US)

(73) Assignee: Caltherm Corporation, Columbus, IN (US)

(21) Appl. No.: 13/984,385

(22) PCT Filed: Feb. 8, 2012
(86) PCT No.: PCT/US12/24354

§ 371 Date: Sep. 5, 2013

Related U.S. Application Data
(60) Provisional application No. 61/440,452, filed on Feb. 8, 2011.

(51) Int. Cl. G05D 23/185

(52) U.S. Cl. CPC G05D 23/1852
USPC 236/99 K; 236/101 A

(57) ABSTRACT

A dual-valve reverse poppet thermostat for use in a vehicle cooling system. The thermostat includes a cup having a temperature sensitive element that actuates a piston causing the piston to move axially upwards. Movement of the piston initiates the gradual opening of a preliminary valve to initiate coolant flow and equalize pressure to open a main valve. The preliminary valve and main valve are biased towards a closed position by biasing spring members.

### CROSS-REFERENCE TO RELATED APPLICATIONS

This application claims priority to U.S. Provisional Patent Application No. 61/440,452 filed on Feb. 8, 2011, and PCT Application No. PCT/U.S. 2012/024354 filed on Feb. 8, 2012, which are hereby incorporated by reference in their entireties.

### BACKGROUND

The present disclosure relates generally to the field of thermostats and more particularly, to a dual-valve reverse poppet thermostat.

### DESCRIPTION OF THE RELATED ART

Thermostatic valve devices or thermostats are routinely used to control heat transfer within a system by controlling flow of a fluid within the particular system. The fluid may be in various forms, such as liquid or a gas. An example of a system is coolant circulating through the cooling system associated with an internal combustion engine to control heat transfer. Depending on the temperature within the system, the valve may be in an open position, a closed position, or a partially open position to regulate fluid flow within the system. In a conventional thermostat, the thermostatic valve may have a relatively large cross section so that when the valve is opened, a relatively large flow of fluid can pass through the valve at a predetermined rate.

While the present dual valve, reverse poppet thermostats work, the flow characteristics of the overall system may necessitate the use of a large sized valve. In addition, the construction of the valve including the type of material used may influence the laminar flow characteristics of the valve.

Accordingly, there is a need to provide an improved dual valve thermostat that is more compact and enhances the control of fluid and resultant heat transfer within a system. In addition, there is a need for a thermostat that is fabricated from plastic to improve laminar flow.

### SUMMARY

Accordingly, the present disclosure relates to a dual-valve reverse poppet thermostat for use in a vehicle cooling system. The thermostat includes a cup having a temperature sensitive element that actuates a piston causing the piston to move axially upwards. Movement of the piston initiates the gradual opening of a preliminary valve to initiate coolant flow and equalize pressure prior to opening of a main valve. The preliminary valve and main valve are biased towards a closed position by biasing spring members.

The present application describes a dual-valve reverse poppet thermostat for use in a vehicle cooling system, the thermostat. The thermostat includes a cup having a lower end coupled to a cup retainer and an opposed upper end having a collar, and the cup contains a temperature sensitive element therein. The thermostat further includes a piston having an upper end and an opposed lower end, and the piston extends from the cup upper end, wherein the piston is configured to be actuated and axially moved with respect to the cup in response to a change in temperature of the element. The thermostat also includes a valve member having an upper end including a surface and an opening, and a lower end including an annular rim extending therefrom and having a contoured surface, the valve member positioned on top of the cup and partially housing the cup such that the valve member upper end surface mates with the collar and creates a preliminary valve. The thermostat additionally includes a ring-shaped seat member having an upper end including an annular rim extending therefrom and an opposed lower end including a contoured surface extending outwardly therefrom, the ring-shaped seat member is situated over and concentrically housing the valve member such that ring-shaped seat member contoured surface mates with the valve member contoured surface and creates a main valve. The thermostat also includes an outlet strap structure having a middle portion coupled to the piston upper end, a lower portion, a first side strap extending down the side of the piston and coupled to the seat member, and an opposed second side strap extending down the side of the piston and coupled to the seat member. The thermostat further includes an upper biasing spring member having an upper end extending above the piston and an opposed lower end positioned on top of the outlet strap structure lower portion, the upper biasing spring positioned concentrically over the outlet strap structure. The thermostat additionally includes a lower biasing spring member having an upper end adjacent the valve member and an opposed lower end adjacent a bypass valve, wherein the upper biasing member biases the valve member and bypass valve towards a closed position.

An advantage of the present disclosure is that a dual-valve reverse poppet thermostat is provided which maximizes fluid flow and minimizes restriction to improve the heat transfer within the system. Another advantage is that the dual-valve reverse poppet thermostat eliminates various components found in conventional thermostats. Yet another advantage of the present disclosure is that the dual-valve reverse poppet thermostat has an improved strength to weight characteristic. Still yet another advantage of the present disclosure is that the dual-valve reverse poppet thermostat has an exo-skelatal structure. A further advantage of the present disclosure is the thermostat housing may be fabricated using plastic parts while retaining the strength characteristics of the thermostat. Still yet a further advantage of the present disclosure is that the use of plastic improves the laminar flow characteristics of the valve. Yet a further advantage of the present disclosure is that the first valve opens to initiate flow and equalize pressure prior to opening the second, larger, full-flow valve.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of a dual-valve reverse poppet thermostat, according to an exemplary embodiment.

FIG. 2 is a top view of the dual-valve reverse poppet thermostat of FIG. 1.

FIG. 3 is sectional view of the dual-valve reverse poppet thermostat of FIG. 2 taken through line 3-3.

FIG. 4 is a sectional view of the thermostat of FIG. 3 with a preliminary valve open.

FIG. 5 is another sectional view of the thermostat of FIG. 3 with a main valve open.

FIG. 6 is a perspective view of another embodiment of a thermostat.

FIG. 7 is a top view of the thermostat of FIG. 6.

FIG. 8 is sectional view of the thermostat of FIG. 7 taken through line 9-9.

FIG. 9 is a sectional view of the thermostat of FIG. 7 with a main valve open.

### DESCRIPTION

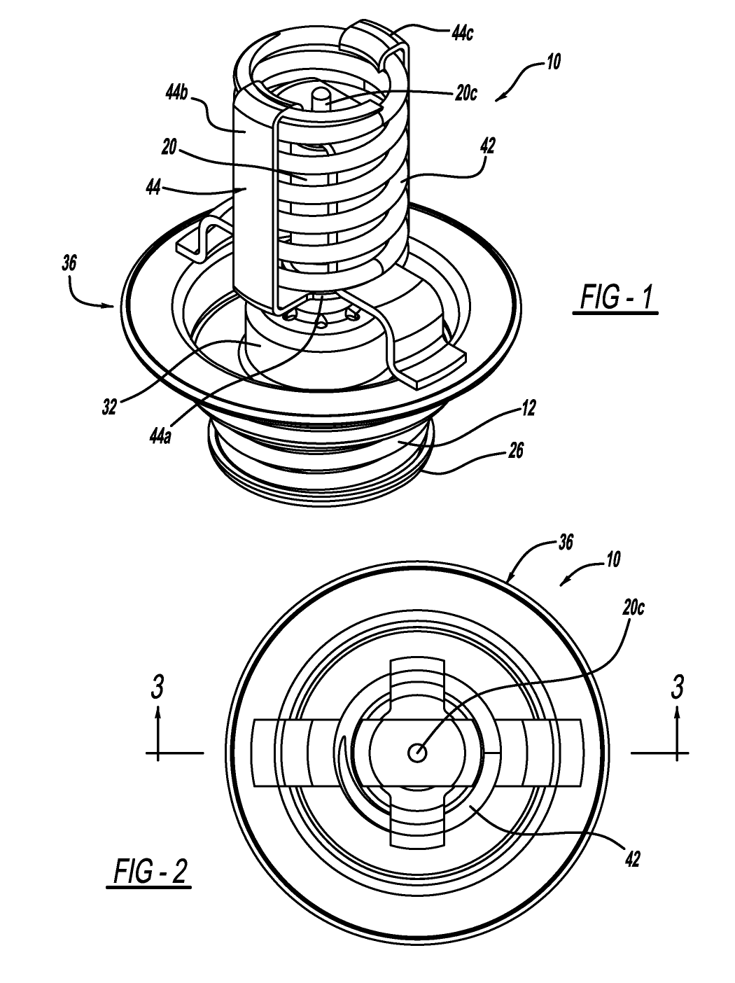

Referring generally to the figures and particularly to FIGS. 1 - 5, a thermostat 10 is shown. The thermostat of this example is a dual-valve reverse poppet thermostat used to control the flow of fluid within a system 8. In this example, the system 8 is a cooling system associated with the radiator of a motor vehicle, although other types of systems and uses are contemplated. In addition, the dual-valve configuration could be utilized with other types of thermostats.

The thermostat 10 includes a cup 12 having a floor 12a and a sidewall 12b extending upwardly from the floor 12a. An upper edge of the cup side wall 12b includes a circumferentially extending collar 14 for supporting a seal member 15, such as a washer. The seal member 15 is an annular member that circumscribes the piston and forms a seal with the inner valve member 32 in a manner to be described. The cup 12 includes an interior chamber 12c that contains a thermally expansible and contractible element 30. In an example, the thermal element is a wax material or other such reformable material. The wax is solid at a low temperature, but as the temperature in the system heats up, the wax element 30 melts and expands within the cup interior 12c. Conversely, as the wax element 30 cools down, the wax element 30 solidifies and contracts. In an example, the thermostat 10 and composition of the thermal element 30 are designed to operate at predetermined temperature ranges, such as 70° to 90° C. (160° to 200° F.), or the like.

The thermostat 10 includes a piston 20 used to control the operation of the valves in a manner to be described. The piston 20 includes a cylindrically shaped housing 20a having a lower end 20b and an opposed upper end 20c. The piston housing 20a may include a feature that serves as a stop in a manner to be described. For example, a C-clip 50 may be secured to the piston housing 20a at a predetermined position to provide a first stop. A second stop 52 is formed as an annular ring around the piston housing 20a, and serves as a stop for the preliminary valve in a manner to be described. The piston lower end 20b extends upwardly from the cup collar 14. The piston 20 and cup 12 may be integrally formed as one member. A displaceable piston member 22 is supported within an interior of the piston housing 20a. A lower end of the piston member 22 is operatively in connected to the wax element 30. The piston member 22 is an elongated shaft that travels within the piston housing 20a due to the thermal expansion and contraction of the thermal element 30.

The thermostat 10 includes a cup retainer 24, which provides a support surface for the cup 12. The cup retainer 24 may be coupled to another valve, which in this example is a bypass valve 26. The bypass valve 26 balances and stops the fluttering of a main valve 28. The bypass valve 26 also functions to help vent any gas that may have entered the cooling system of this example. The bypass valve 26 also enables a small flow of fluid 80 past the thermostat 10 to ensure that the thermostat 10 experiences the temperature change in the fluid 80 as the environment heats up.

The thermostat 10 includes a main valve 28 that services as an inlet, and a preliminary valve 34 that serves as an outlet for fluid flow 80. The preliminary valve includes an inner valve member 32 and the seal member 15. The main valve 28 includes a portion of the inner valve member 32 and the outer valve member 36. The inner valve member 32 includes an annular first wall 32a that is positioned adjacent the cup collar 14. The inner valve member 32 includes a second wall 32b extending upwardly from an inner edge of the first wall 32a and circumferentially around the piston housing 20a. The inner valve member 32 also includes a third wall 32c extending downwardly from an outer edge of the first wall 32a. The third wall 32c is spaced a predetermined distance from the cup collar 13. The inner valve member 32 further includes a fourth annular wall 32d extending outwardly from a lower edge of the third wall 32c, and circumferentially around the third wall 32c. The annular wall 32d may include a contoured flange or surface 32e extending downwardly from an outer edge. The inner valve member 32 at least partially houses the cup 12, such that the piston housing 20 extends upwardly through a central passageway 32f within the inner valve member 32. An interior surface of the inner valve member wall 32a surface is adjacent the seal member 15 to establish a first or preliminary valve 34. The preliminary valve 34 initially opens a predetermined amount to allow a predetermined initial flow of fluid 80 in a manner to be described. This initial flow may prevent a sudden forceful in-flush of fluid.

The outer valve member 36 includes an annular first wall 36a that is spaced a predetermined distance outboard of the inner valve member first wall. A seal member 16 may encase the outer valve member first wall 36a. An example of a seal member 16, is a gasket. A second outer valve member wall 36b extends downwardly from an inner edge of the outer valve member first wall 36a. The outer valve member second wall 36b is spaced a predetermined distance outboard of the inner valve member third wall 32c. A lower edge of the outer valve member second wall 36b includes an outwardly extending contoured surface or flange 36c. The outer valve flange 36c is adjacent the inner valve flange 32e, and together form the main valve 28. The outer valve member 36 and inner valve member 32 cooperatively from a valve chamber 35 that serves as a passageway for the fluid 80.

The thermostat 10 also includes a strap or frame 40 that provides rigidity and support. The frame 40 is a u-shaped member having a first leg 40a, an opposed second leg 40b, and a third leg 40c extending between an upper end of the first leg and upper end of the second leg 40b. The third leg 40c may be coupled to the piston upper end 20c and includes an opening 40d through which the piston 20 extends therethrough. The first leg 40a and second leg 40b generally extends downwardly along opposite sides of the piston 20 at a predetermined distance, such that there is a space therebetween. A lower end of the first leg 40a and a lower end of the second leg 40b may extend into the interior chamber formed between the inner valve member 32 and outer valve member 36. In another example, the lower end of the first leg and lower end of the second leg are adjacent to an inner surface of the outer valve member first wall 36a. The first leg lower end and second leg lower end may be fixedly secured to the inner surface of the outer valve member first wall 36a, such as by welding, press assembly or the like. In another example, the first leg lower end 40d and second leg lower end 40c may be coupled to an outer surface of the outer valve second wall 36b. The first leg 40a and second leg 40b may be coupled to the seat member 36 also by using a variety of techniques, such as, welding, press assembly, or the like.

The thermostat 10 also includes a first or lower biasing member 38, such as a spiral spring, a compression spring, or the like. The first biasing member 38 is positioned between the inner valve member 32 and the cup retainer 24, and encircles the cup 12. The first biasing member 38 includes an upper end 38a and an opposed lower end 38b. The first biasing member upper end 38a is coupled to the inner valve member lower end 32d and biases the valve member 32 in an upward direction to initially keep the preliminary valve 34 and the main valve 28 closed. The first biasing member lower end 38b is coupled to the bypass valve and operatively biases the bypass valve 26 in a downward direction to keep the bypass valve 26 closed. The first biasing member 38 guides movement of the inner valve member 32 and the bypass valve 26. The first biasing member 38 also helps with alignment of the inner valve member 32 with respect to the outer valve member 36 and alignment of the bypass valve 26 with the cup retainer 12.

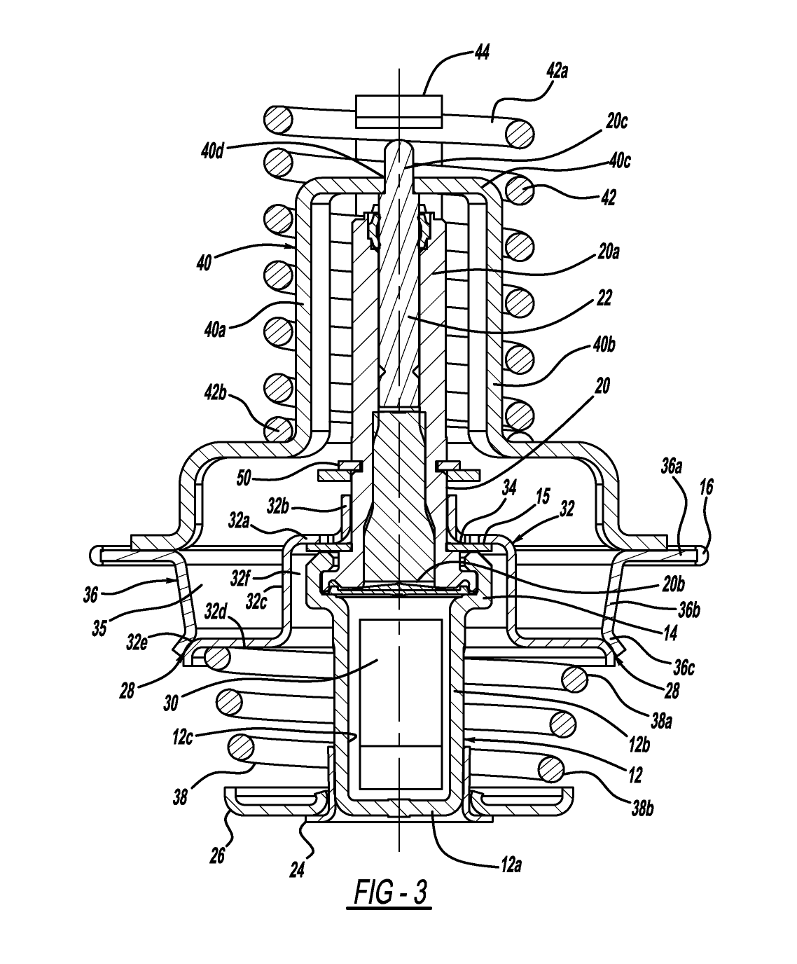

The thermostat 10 also includes a second or upper biasing member 42, such as a spiral spring, a compression spring, or the like. The second biasing member 42 may be positioned over the frame 40 such that the second biasing spring 42 encircles the frame 40 and the piston 20. The second biasing member 42 includes an upper end 42a and an opposed lower end 42b. The second biasing member upper end 42a extends a predetermined distance above the piston upper end 20c. The second biasing member lower end 42b is supported on integrally formed support surface formed in each of the first leg and second leg. The second biasing member biases the frame 40 and outer valve member 36 in a downward direction to keep the main valve 28 closed as shown in FIG. 3. The second biasing member 42 also assists in guiding movement of the outer valve member 36 and alignment of the seat member 36 with the valve member 32.

The thermostat 10 also includes a biasing member retainer 44 that provides support to the second biasing member 42. The biasing member retainer 44 includes a ring portion 44a, a first retainer strap 44b, and an opposed second retainer strap 44b. The ring portion 44a is mounted onto the piston 20, such that the piston 20 extends upwards through the opening. The first retainer strap 44b and the second retainer strap 44b generally extend outwardly and upwardly along opposite sides of the second biasing member 42 at a predetermined distance such that there is a space between the retainer straps 44b, and the second biasing member 42. The end 44c of the first retainer strap 44b and second retainer strap 44c each have a curved hook-like portion that receives a portion of the second biasing member upper end 42a and thereby secure the second biasing member 42 in position. The biasing member retainer 44 also guides the movement of the piston 20 and the alignment of the piston 20, seat member 36, and valve member 32.

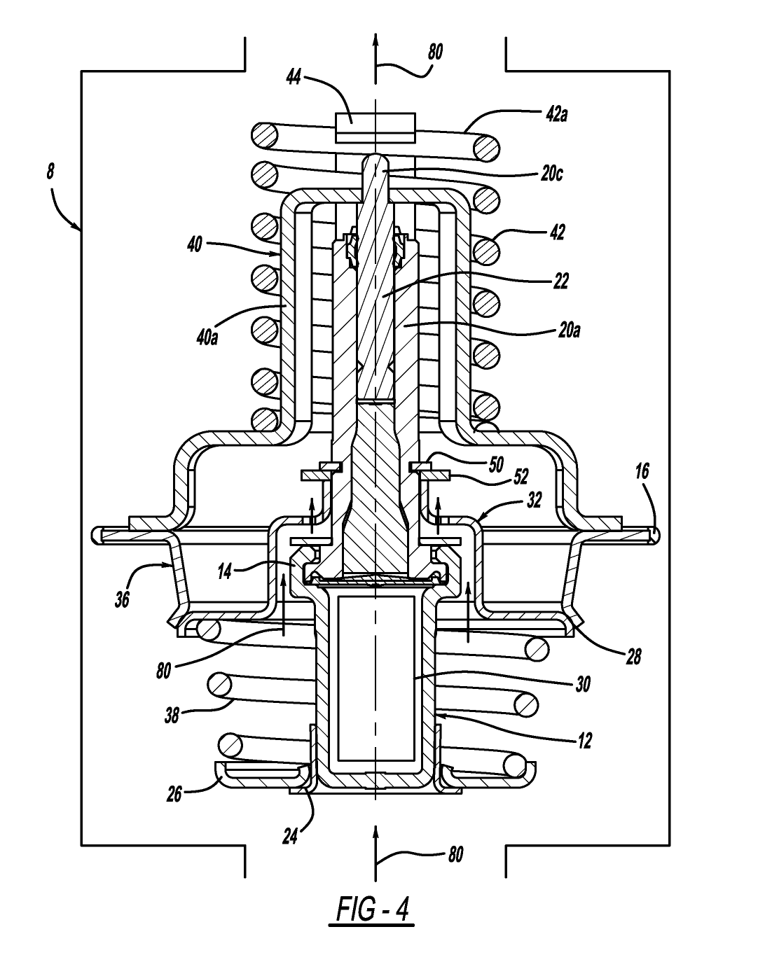

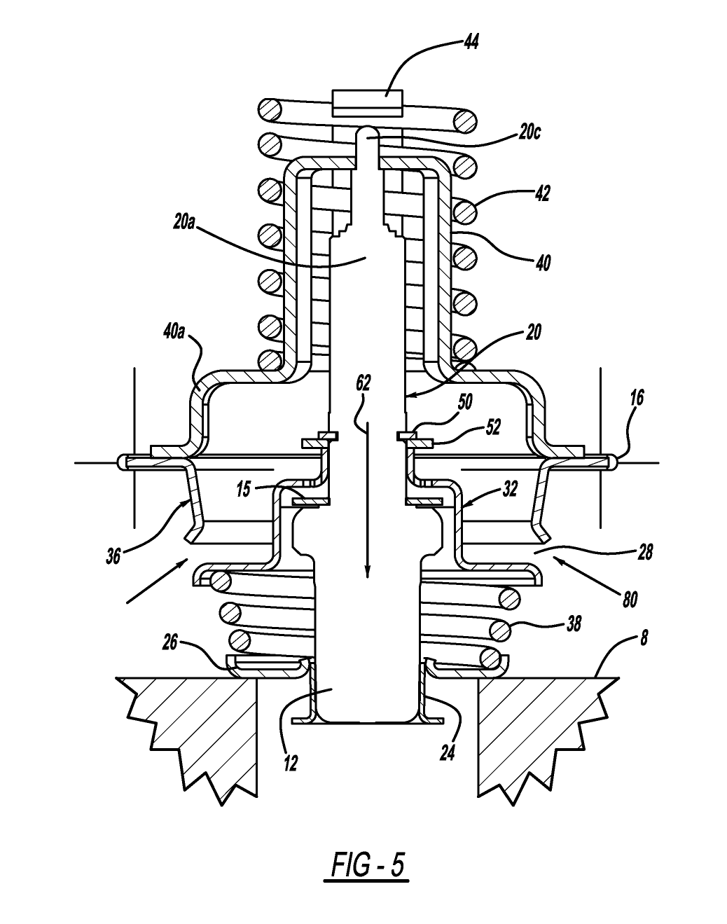

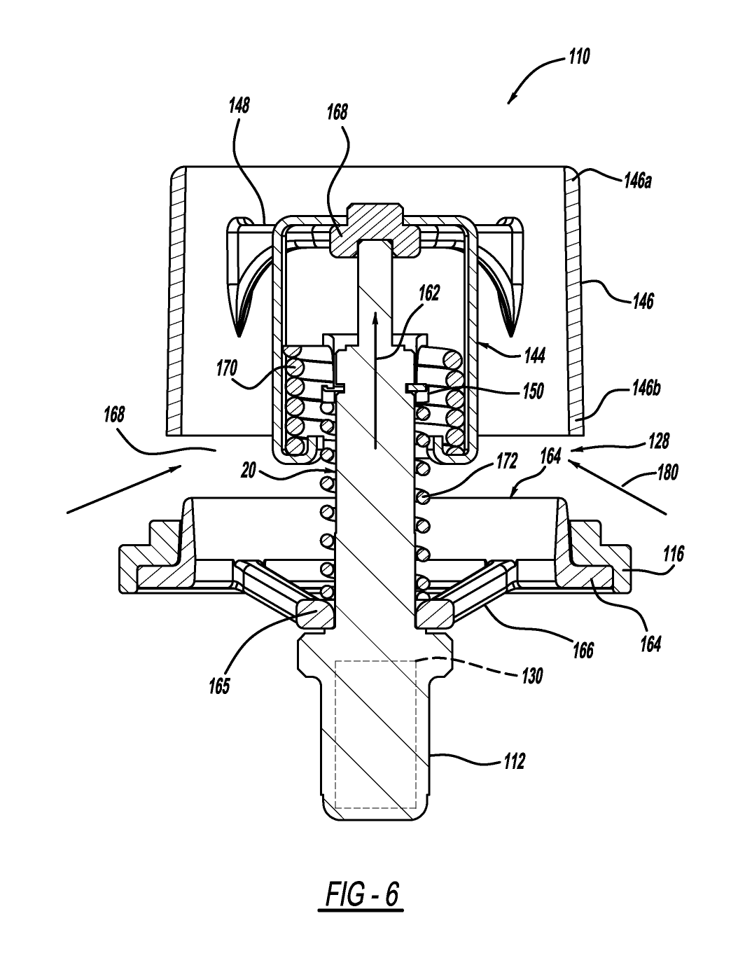

In operation, the preliminary and main valves 28, 34 of the thermostat 10 are initially closed as shown in FIG. 3. In the example of an engine cooling system, closure of the valve prevents coolant from flowing from the engine jacket to the radiator. When the engine is started, and as the engine warms up, the circulating coolant fluid transfers heat from the engine block. The thermostat is positioned in the system, so that as the coolant reaches a predetermined temperature, the heat sensitive and thermally expansible element 30 begins to gradually melt and expand. The expansion of the element 30 actuates the piston 20 and raises the piston member 22 in an upward direction against the outlet strap structure 40 thereby directing movement of the piston 20 as shown at 62. This movement causes the seal element 15 to be pushed in a downward direction, and the inner valve member second wall 32b rises. This movement gradually creates a gap for the preliminary valve 34. As the wax element continues to gradually melt and expand further, the cup 12 and seal/washer 14 continue to move downward until stopped by the second stop 52, completely opening the preliminary valve 34 and enabling a preliminary flow of fluid 80 therethrough as illustrated in FIG. 4. As the element 30 expands still further, the piston 20 moves further downward engaging and pushing the inner valve member 32 in a downward direction. This causes the main valve 28 to gradually open and enabling a main flow of coolant 80 therethrough as shown in FIG. 5. As the coolant cools, such as by turning off the engine, the element 30 begins to cool, contract and solidify. The valves gradually close with the aid of the biasing members as the process gradually reverses.

The thermostat 10 advantageously has two-stages of opening. The preliminary valve 34 thus opens to initiate flow and may equalize pressure prior to the opening of the main valve 28. This regulated flow of fluid dampens the flow and enhances cooling dynamics at the critical initial opening of the thermostat 10, such as that due to pressure spikes, valve oscillations, temperature oscillations, or the like. The bypass spring or lower biasing member 38 has a dual function in that it also absorbs over-travel associated with over-temperature by providing a closing force on the bypass valve 26. It also centers the element/line-of-action to enable the two-stage opening feature while maintaining structural rigidity. The thermostat 10 also has a relatively high exposed flow area. The entry is flush with the housing wall so that the entire stroke of the element 30 is available to produce flow area. The bypass spring for structural stability eliminates the need for a guiding feature in the middle of the flow path. The thermostat 10 has no perimeter feature(s) above the seat 36 (except for the “strap” 40) thereby enabling full use of the outlet housing internal diameter for flow.

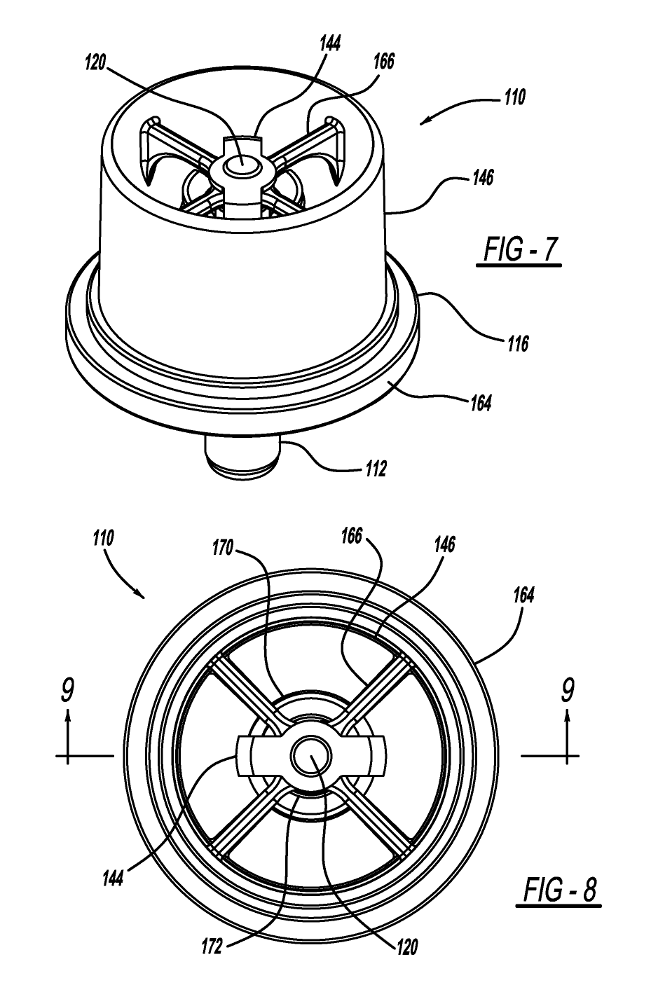

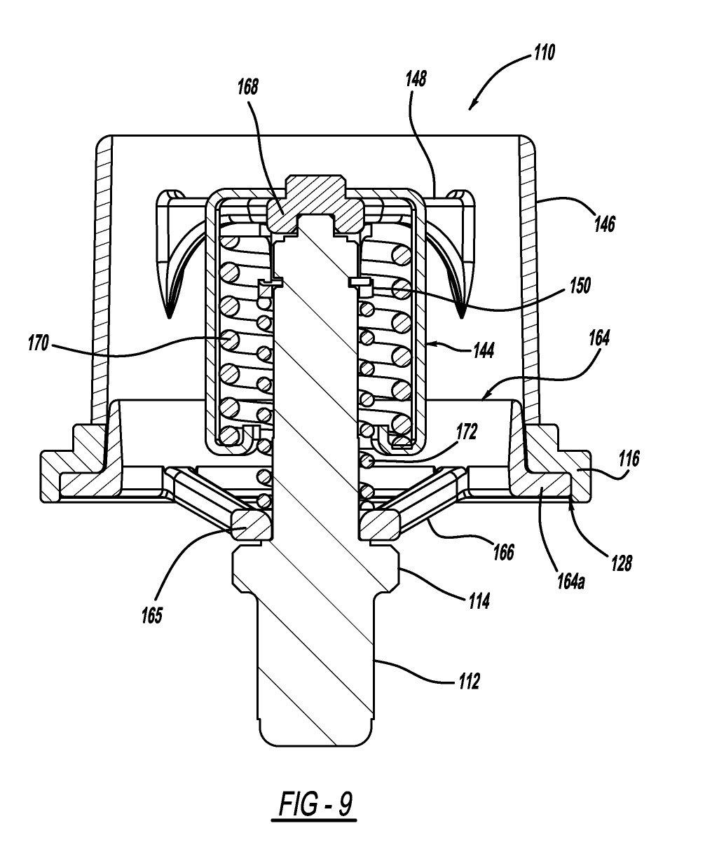

Referring now to FIGS. 7-9, another embodiment of a thermostat 110 is shown Like features have like reference numeral increased by 100. The thermostat 110 includes a cup 112 containing an element 130 of known material, such as a wax, which expands in response to temperature rising above a predetermined level thereby actuating a piston 120, as previously described. In an example of a heavy duty engine, the cup 112 may be mounted in a thermostat housing of the engine.

The main valve 128 includes an outer annular wall 164 concentrically arranged about the piston 120 and spaced a predetermined distance from the piston 120. The outer annular wall 164 includes a flange 164a extending outwardly from a lower edge of the outer annular wall 164. The main valve 128 also includes an inner annular wall 165 that encircles the piston 120. A plurality of spokes 166 interconnect the inner annular wall 166 and the outer annular wall 164. The inner annular wall 166 is supported by the cup collar 114. The outer annular wall 166 and spokes 166 concentrically surround the piston cylindrical body and allows flow through an interior 168 of the thermostat 110. A seal ring member 116, such as a gasket, or the like, is positioned over an outer surface of the outer annular wall 164 to form a seal.

A cylindrical outlet sleeve 146 having an upper edge 146a and an opposed lower edge 146b is positioned on top of the outer annular wall 164, and engages the seal member 116 to form a seal when the main valve is closed. The outlet sleeve 146 includes a plurality of spokes 148 extending radially inward from an upper edge of the outlet sleeve 146. The spokes 148 are secured to a second annular ring 168 which encircles the upper end of the piston 120. The outlet sleeve 146 cooperates with the outer annular wall 136, seal member 116, and piston 120 to define a movable valve element for the mail valve 128.

In an example of a thermostat 110 used in a heavy duty engine, cooling liquid 180 flows around the cup 112 past the first spokes 166, through the outlet sleeve 146, and exits the valve beyond the outlet sleeve spokes 148 to a first chamber which is connected to a line bypassing the radiator of the vehicle and returning to a cooling liquid inlet in the engine. As the wax in the cup 12 gets warmer and expands, the piston 120 moves the outlet sleeve 146 upward, thereby reducing the flow into the first chamber and initiating flow into a second chamber, which is connected to the radiator of the vehicle. When the engine is sufficiently warmed up, the flow of cooling fluid is entirely into the second chamber.

The thermostat 110 also includes an outer biasing member or return spring 170, such as a spiral spring, compression spring, or the like, to return the outlet sleeve 146 to tight engagement with the outer annular wall 166 through biasing member retainer 144 when the cooling liquid in the engine cools and the wax element 130 contracts. The biasing member retainer 144 is disposed around the piston and outer biasing number 170. The thermostat 110 also includes an inner biasing member or over-travel spring 172, such as a spiral spring, compression spring, or the like, which enables the cup 112 to move when the outlet sleeve 146 is fully open and the wax expands more. Both the outer biasing member 172 spring and the inner biasing member 172 are arranged and operate in a conventional manner.

The components of the thermostat 110 can be fabricated from a variety of predetermined materials to enhance and optimize performance of the thermostat 110 and cooling system. For example, the components can be made from materials, such as steel, stainless steel, aluminum, plastic, or the like. In an example, the outer annular wall 164 and outlet sleeve 146 may be formed from plastic which provides a number of advantages.

The plastic thermostat enables more components to be fabricated with more streamlined contours for better flow characteristics. As such, it is possible to contour-in variable flow area features as the thermostat 110 opens. The use of plastic in the thermostat enables forming of components that are more consistent with one another as opposed to stamped components. This provides the ability to tighten tolerances between components and improves component quality. The plastic thermostat enables a reduction of parts and elimination of thermostat components, such as, o-rings, seals, or the like.

Many modifications and variations of the present disclosure are possible in light of the above teachings. For example, it is noted that various components of the dual-valve reverse poppet thermostat can also be formed from plastic. Therefore, within the scope of the appended claim, the present disclosure may be practiced other than as specifically described.

What is claimed is:

1. A dual-valve reverse poppet thermostat comprising:
a cup having a floor coupled to a cup retainer, a sidewall extending upwardly from the floor, and a circumferential collar located at an upper end of the sidewall;
a temperature sensitive element located within the cup;
a piston having a cylindrical housing that extends from the cup upper end and a displaceable piston member disposed within the housing, wherein a lower end of the piston member is adjacent the temperature sensitive element, and the piston is actuated in response to a change in temperature of the element and is displaced axially with respect to the cup;
a preliminary outlet valve having a displaceable inner valve member circumferentially positioned the piston and above the cup collar positioned, wherein a first displacement of the inner valve member releases an initial flow of fluid from the thermostat;
a main inlet valve member having a seat member concentrically situated around the piston such that the seat member is adjacent a corresponding surface of the inner valve member, wherein a second displacement of the inner valve member opens the main inlet valve for full flow of fluid through the seat member;
a support frame having a first an opposed second leg and a third leg extending between the first leg and second leg, wherein a lower end of each of the first leg and second leg is secured to the seat member, and the third leg supports an upper end of the piston; and
an upper biasing member positioned concentrically over the support frame; and
a lower biasing member disposed between the cup retainer and cup floor, wherein heating of the element initially displaces the piston upwardly, and the upper biasing member and tower biasing member displaces the piston downwardly to open the main valve.

2. The dual-valve reverse poppet thermostat of claim 1, wherein the inner valve member includes an annular first wall, a second wall extending upwardly from an inner edge of the first wall, a third wall extending downwardly from an outer edge of the first wall, and a fourth annular wall extending outwardly from a lower edge of the third wall and circumferentially around the third wall.

3. The dual-valve reverse poppet thermostat of claim 1, wherein the outer valve member includes an annular first wall, second wall extending downwardly from an inner edge of the first wall.

4. The dual-valve reverse poppet thermostat of claim 1, further comprising a sealing washer positioned on the cup collar.

5. The dual-valve reverse poppet thermostat of claim 1, further comprising a radially extending stop located on the piston to limit displacement of the inner valve member while opening the preliminary valve.

6. The dual-valve reverse poppet thermostat of claim 1 wherein the temperature sensitive element is a wax element, and the wax element melts and expands as a temperature increases, and the wax element solidifies and contracts as the temperature decreases.

7. The dual-valve reverse poppet thermostat of claim 1, wherein the seat member has a diameter which is the same or smaller than a diameter of the valve member lower end.

8. The dual-valve reverse poppet thermostat of claim 1, further comprising a biasing retainer member having a ring portion, a first retainer strap and a second retainer strap, wherein the ring portion is mounted on the piston, and the first retainer strap and second retainer strap are secured to the seat member and the upper biasing member to constrain displacement of the upper biasing member.

9. The dual-valve reverse poppet thermostat of claim 1, wherein the lower biasing member is a spring that initially biases the inner valve member in an upward direction to keep the preliminary valve and main valve in a closed position.

10. The dual-valve reverse poppet thermostat of claim 1, wherein the upper biasing member is a spring member that initially biases the frame and seat member in a downward direction to keep the main valve closed.

11. The dual-valve reverse poppet thermostat of claim 12, wherein the upper biasing member upper extends a predetermined distance above the piston upper end.

12. The dual-valve reverse poppet thermostat of claim 1, wherein the seat member is concentrically situated around the inner valve member.

13. The dual-valve reverse poppet thermostat of claim 1, wherein at a predetermined temperature, the temperature sensitive element expands and pushes the piston in an upward direction against the frame and opens the preliminary valve enabling a preliminary flow of coolant therethrough.

14. The dual-valve reverse poppet thermostat of claim 1, wherein at another predetermined temperature, the piston pushes the valve member in a downward direction and opens the main valve enabling a main flow of coolant therethrough.

15. A thermostat comprising;
a cup having a floor and a sidewall extending upwardly from the floor, and a circumferential collar located at an upper end of the sidewall;
a temperature sensitive element located within the cup;
a piston having a cylindrical housing that extends from the cup upper end and a displaceable piston member disposed within the housing, wherein a lower end of the piston member is adjacent the temperature sensitive element, and the piston is actuated in response to a change in temperature of the element and is displaced axially with respect to the cup;
a main valve having an outer annular wall that is spaced apart from the piston and an inner annular wall that circumscribed the piston, and a plurality of spokes extending between the outer annular wall and inner annular wall;
a seal ring member coupled to a portion of the annular outer wall;
a cylindrical outlet sleeve having an upper edge and an opposed lower edge and that is positioned on top of the outer annular wall and displaceable with respect to the outer annular wall, the cylindrical outlet sleeve including a plurality of outlet sleeve spokes that interconnect the outlet sleeve with a second annular ring that circumscribes the upper end of the piston, wherein the cylindrical outlet sleeve lower edge is positioned adjacent to atop portion of the seat member to engage the seal ring member;
an outer biasing member configured to bias the cylindrical outlet sleeve with respect to the seat member; and
an inner biasing member configured to displace the cup when the cylindrical outlet sleeve is fully open.

16. The heavy duty thermostat of claim 15, wherein the seat member is formed of plastic.

17. The heavy duty thermostat of claim 15, wherein the outlet sleeve is formed of plastic.
